(19) United States
(12) Patent Application Publication
(10) Pub. No.: US 2025/0093599 A1
(43) Pub. Date: Mar. 20, 2025

(54) OPTICAL MODULE ASSEMBLY

(71) Applicant: Electronics and Telecommunications Research Institute, Daejeon (KR)

(72) Inventors: Won-Bae KWON, Daejeon (KR); Eun Kyu KANG, Daejeon (KR); Jong Jin LEE, Daejeon (KR); Soo Yong JUNG, Daejeon (KR); Haechung KANG, Daejeon (KR); Sangjin KWON, Daejeon (KR); Myunghwan KIM, Daejeon (KR)

(73) Assignee: Electronics and Telecommunications Research Institute, Daejeon (KR)

(21) Appl. No.: 18/883,663

(22) Filed: Sep. 12, 2024

(30) Foreign Application Priority Data
Sep. 20, 2023 (KR) 10-2023-0125333

(51) Int. Cl. G02B 6/42

(52) U.S. Cl. CPC G02B 6/4281; G02B 6/4246; G02B 6/4251; G02B 6/4267; G02B 6/4269; G02B 6/4278; G02B 6/4279

(57) ABSTRACT

An optical module assembly is provided. The optical module assembly includes an electric sub-assembly including a printed circuit board (PCB) and an electronic device mounted on the PCB and an optical module including an interposer including a transparent material, an optical sub-assembly accommodating optical components, and a cover covering an upper portion of the optical sub-assembly, wherein one end portion of the PCB is inserted into the optical sub-assembly through an inserting hole formed in a sidewall of the optical sub-assembly, and the optical components and a substrate electrode formed on a surface of the one end portion of the PCB are electrically connected to each other by the interposer.

### CROSS-REFERENCE TO RELATED APPLICATIONS

This application claims the benefit of the Korean Patent Application No. 10-2023-0125333 filed on Sep. 20, 2023, which is hereby incorporated by reference as if fully set forth herein.

### BACKGROUND

### Field of the Invention

The present invention relates to an optical module assembly, and more particularly, to an optical module assembly for minimizing radio frequency (RF) transmission loss.

### Discussion of the Related Art

FIG. 1 is a diagram for describing a quad small form factor pluggable (QSFP) or octal small form factor pluggable (OSFP) optical module assembly of the related art.

Referring to FIG. 1, the optical module assembly of the related art includes a transmitter optical sub-assembly (TOSA) 10 which converts an electric signal into an optical signal, a receiver optical sub-assembly (ROSA) 20 which converts an input optical signal into an electric signal, an electric sub-assembly (ESA) 30 which includes a printed circuit board (PCB) 32 and an electronic device 34 mounted on the PCB 32, and a flexible PCB (FPCB) 60 which electrically connects the TOSA 10 and the ROSA 20 to the ESA 30.

The FPCB 60 may secure easiness in a bonding process between the FPCB 60 and the ESA 30, based on a flexible material characteristic. However, because a thickness of the FPCB 60 should be designed to be thin for securing flexibility, there is technical difficulty in that a line width of a transmission line should be reduced and a manufacturing process error of a line width should be minimized, for the accuracy and impedance matching of a high frequency transmission line.

Moreover, the FPCB 60 should be designed to have a certain length Lfpcb, for securing flexibility, and due to this, high frequency transmission loss increases, an electric bandwidth is reduced, and a miniaturization design of the optical module assembly is difficult.

Moreover, because the FPCB 60 includes an opaque material, it is difficult to discern a position for aligning an electrode of the PCB 32 and an electrode of the FPCB 60. Due to this, an alignment error between two electrodes in a bonding process between the FPCB 60 and the ESA 30 occurs. Due to such an alignment error, impedance mismatching may occur in an electrode bonding part 62.

Moreover, in order to connect the electrode of the FPCB 60 to optical devices included in the TOSA 10 and the ROSA 20, a package feedthrough 70 is designed on an outer wall of each of the TOSA 10 and the ROSA 20 generally, and due to this, the total price of an optical module increases.

### SUMMARY

An aspect of the present invention is directed to providing an optical module assembly in which an FPCB (60 of FIG. 1) and a package feedthrough (70 of FIG. 1) may be replaced with an interposer which is low in high frequency transmission loss and includes a transparent material enabling an electrode position to be easily discerned, and thus, a transmission line length and a connection distance between optical components in an optical sub-assembly and electrodes of a PCB configuring an electric sub-assembly may be minimized to enhance an electric bandwidth, and the miniaturization and manufacturing cost may be reduced.

To achieve these and other advantages and in accordance with the purpose of the invention, as embodied and broadly described herein, there is provided an optical module assembly including: an electric sub-assembly including a printed circuit board (PCB) and an electronic device mounted on the PCB; and an optical module including an interposer including a transparent material, an optical sub-assembly accommodating optical components, and a cover covering an upper portion of the optical sub-assembly, wherein one end portion of the PCB is inserted into the optical sub-assembly through an inserting hole formed in a sidewall of the optical sub-assembly, and the optical components and a substrate electrode formed on a surface of the one end portion of the PCB are electrically connected to each other by the interposer.

In an embodiment, the optical components may be mounted on the interposer.

In an embodiment, the optical component may be electrically connected to the substrate electrode by a through via passing through the interposer and an electrode pattern patterned at an inner portion and a surface of the interposer.

In an embodiment, the interposer may include: a first interposer disposed on an optical module mount formed on an inner bottom surface of the optical sub-assembly; and a second interposer disposed on the first interposer, and a ground pattern with the optical components mounted thereon and a high-speed transmission line electrically connected to the optical components by a bonding wire may be patterned on an upper surface of the second interposer.

In an embodiment, the optical components may be electrically connected to the substrate electrode by two through vias passing through the second interposer and an electrode pattern which electrically connects the two through vias with each other and is formed between the first interposer and the second interposer.

In an embodiment, the optical components may be electrically connected to the substrate electrode by two through vias passing through all of the first interposer and the second interposer and an electrode pattern which electrically connects the two through vias with each other and is formed on a lower surface of the first interposer.

In an embodiment, the optical module mount may include a mount portion protruding in an upward direction from a surface of the optical module mount, a portion of the second interposer being provided on the optical module mount, and the second interposer may include a radiating via for transferring heat, occurring in the optical components, to the mount portion.

In an embodiment, the optical module mount and the mount portion may be provided as one body, and heat occurring in the optical components may be transferred to the optical sub-assembly through the optical mount module including the mount portion and the radiating via.

In an embodiment, the optical module mount and the optical sub-assembly may include a material which is good in heat transfer characteristic, for smoothly dissipating heat occurring in the optical components to the outside, and the material may include one of aluminum oxide (Al₂O₃), a copper-tungsten (CuW) alloy, silicon (Si), and a composition of at least two materials thereof.

In an embodiment, an opening portion may be formed in a bottom surface of the optical sub-assembly, so as to align positions of an electrode of the interposer and the substrate electrode of the PCB with eyes, and the PCB and the interposer may be bonded to a solder bump melted by a high power laser passing through the opening portion.

In an embodiment, the optical module assembly may further include a sealant for sealing the opening portion when bonding between the PCB and the interposer is completed.

In an embodiment, the sealant may include an epoxy-based material.

It is to be understood that both the foregoing general description and the following detailed description of the present invention are exemplary and explanatory and are intended to provide further explanation of the invention as claimed.

### BRIEF DESCRIPTION OF THE DRAWINGS

FIG. 1 is a diagram for describing a quad small form factor pluggable (QSFP) or octal small form factor pluggable (OSFP) optical module assembly of the related art.

FIG. 2 is a side view of an optical module assembly according to an embodiment of the present invention.

FIG. 3 is a plan view as an internal structure of an optical package module is seen from above in a state where a cover of FIG. 2 is removed.

FIG. 4 is a plan view as the optical package module of FIG. 2 is seen from below.

FIG. 5 is a diagram for describing a bonding process between an interposer of the optical sub-assembly and a printed circuit board of an electric sub-assembly of FIG. 2.

### DETAILED DESCRIPTION OF THE INVENTION

Hereinafter, embodiments of the invention will be described in detail with reference to the accompanying drawings. In describing the invention, to facilitate the entire understanding of the invention, like numbers refer to like elements throughout the description of the figures, and a repetitive description on the same element is not provided.

In the following description, the technical terms are used only for explain a specific exemplary embodiment while not limiting the present invention. The terms of a singular form may include plural forms unless referred to the contrary. The meaning of ‘comprise’, ‘include’, or ‘have’ specifies a property, a region, a fixed number, a step, a process, an element and/or a component but does not exclude other properties, regions, fixed numbers, steps, processes, elements and/or components.

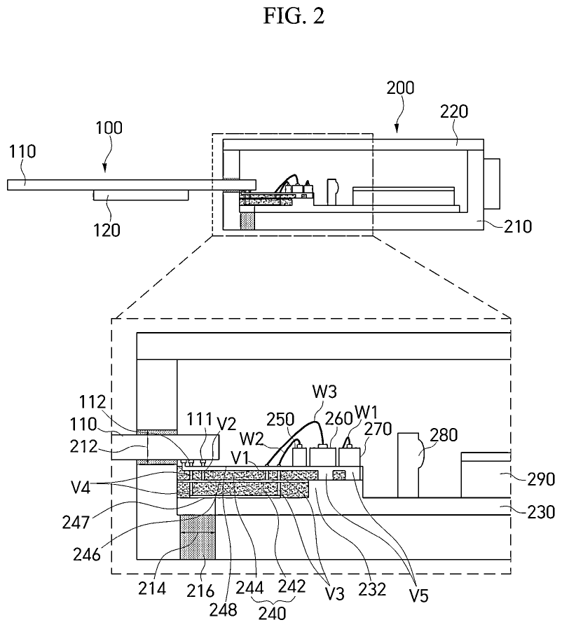

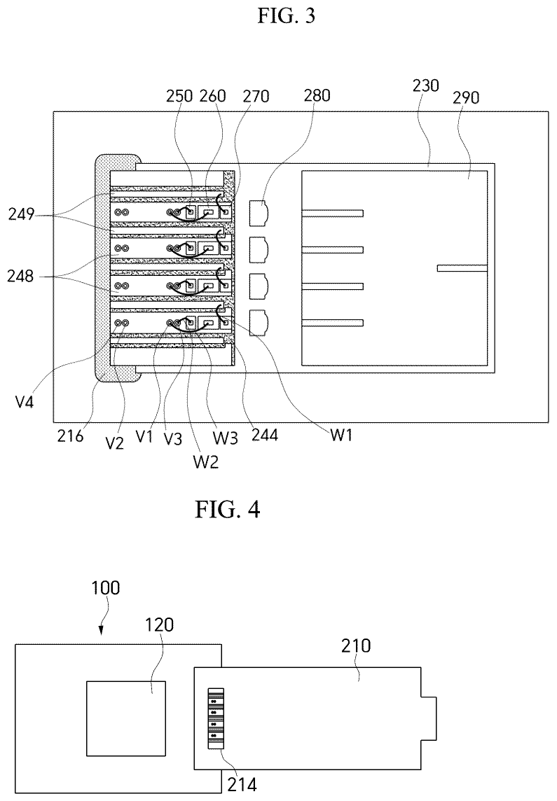

FIG. 2 is a side view of an optical module assembly according to an embodiment of the present invention. FIG. 3 is a plan view as an internal structure of an optical package module is seen from above in a state where a cover of FIG. 2 is removed. FIG. 4 is a plan view as the optical package module of FIG. 2 is seen from below.

Referring to FIGS. 2 to 4, the optical module assembly according to an embodiment of the present invention may include an electric sub-assembly 100 and an optical module 200.

The electric sub-assembly 100 may include a printed circuit board (PCB) 110 and an electronic device 120 mounted on the PCB 110. The optical module 200 may include an interposer 240 which includes a transparent material, an optical sub-assembly 210 which accommodates optical components, and a cover 220 which covers an upper portion of the optical sub-assembly 210. Here, the transparent material may be, for example, glass or plastic.

The optical sub-assembly 210 may include a bottom surface and a sidewall which is bent at an edge of the bottom surface and extends. The cover 220 and the optical sub-assembly 210 may be bonded to each other by a seam sealing process. Accordingly, an internal space of the optical sub-assembly 210 may be isolated from external dust and water.

The PCB 110 of the electric sub-assembly 100 may be electrically connected to the optical component accommodated into the internal space of the optical sub-assembly 210 by using the interposer 240 accommodated into the internal space of the optical sub-assembly 210.

In detail, one end portion of the PCB 110 may be inserted into the optical sub-assembly 210 through an inserting hole 212 formed in a sidewall of the optical sub-assembly 210, and the optical components and substrate electrodes 111 and 112 formed on a surface of the one end portion of the PCB 110 may be electrically connected to each other by the interposer 240.

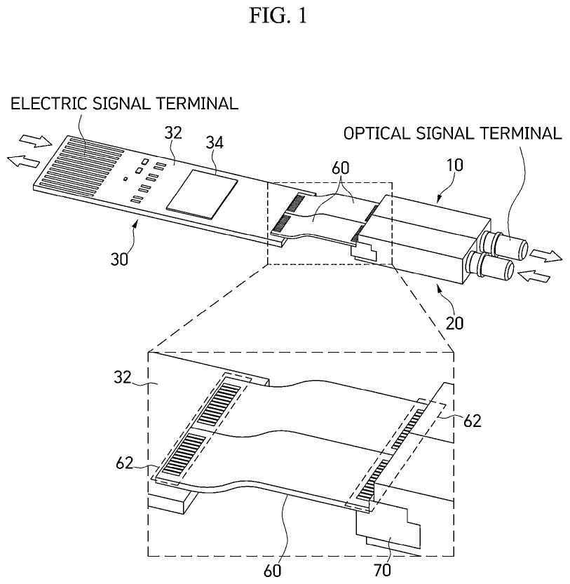

As described above, because the PCB 110 and the optical components are connected to each other by the interposer 240 accommodated into the internal space of the optical sub-assembly 210, the electric sub-assembly 100 and the optical sub-assembly 200 may be directly connected to each other without the FPCB 60 and the package feedthrough 70 of FIG. 1.

In more detail, an optical module mount 230 may be disposed on an inner bottom surface of the optical sub-assembly 210. The optical components may be mounted on the inner bottom surface of the optical sub-assembly 210 by the optical module mount 230.

The interposer 240 and the optical components may be disposed on the optical module mount 230. The optical components may include a photodetector 250, an optical source device 260, an optical modulator 270, an optical collection lens 280, and an optical waveguide 290. In this case, the photodetector 250, the optical source device 260, and the optical modulator 270 may be mounted on the interposer 240.

The optical source device 260 may output light. The optical modulator 270 may modulate light output from the optical source device 260. At this time, the photodetector 250 may monitor light output from the optical source device 260. The light output from the optical source device 260 may be collected by the lens 280. A wavelength of the collected light may be divided and multiplexed by the optical waveguide 290.

The photodetector 250, the optical source device 260, and the optical modulator 270 included in the optical components may be electrically connected to the substrate electrodes 111 and 112 of the PCB 110 by through vias V1 to V4 passing through the interposer 240 and electrode patterns 246 to 248 patterned at an inner portion and a surface of the interposer 240.

In detail, the interposer 240 may include a first interposer 242 disposed on the optical module mount 230 and a second interposer 244 disposed on the first interposer 242.

As illustrated in FIG. 3, ground patterns 248 with the photodetector 250, the optical source device 260, and the optical modulator 270 mounted thereon may be patterned on an upper surface of the second interposer 244. A high-speed transmission line 249 may be patterned between the ground patterns 248. The high-speed transmission line 249 may be electrically connected to the optical modulator 270 by a bonding wire W1.

Four through vias V1 to V4 may be formed in each of the ground patterns 248. Two through vias V1 and V2 of the four through vias V1 to V4 may pass through the second interposer 244, and lower end portions of the two through vias V1 and V2 may be electrically connected to each other by an electrode pattern 246 formed between the first interposer 242 and the second interposer 244.

An upper end portion of the through via V1 may be electrically connected to the optical source device 260 by a bonding wire W3, and an upper end portion of the other through via V2 may be electrically connected to the substrate electrode 111 formed on a surface of the one end portion of the PCB 110 inserted into the optical sub-assembly 210.

Therefore, the optical source device 260 included in the optical components may be electrically connected to the substrate electrode 111 by the two through vias V1 and V2 passing through the second interposer 244 and the electrode pattern 246 which electrically connects the two through vias V1 and V2 with each other and is formed between the first interposer and the second interposer.

Moreover, the other through vias V3 and V4 of the four through vias V1 to V4 may pass through all of the first interposer 242 and the second interposer 244, and lower end portions of the other through vias V3 and V4 may be electrically connected to each other by an electrode pattern 247 formed on a lower surface of the first interposer 242.

An upper end portion of the through via V3 may be electrically connected to the photodetector 250 by a bonding wire W2, and an upper end portion of the through via V4 may be electrically connected to the substrate electrode 112 formed on the surface of the one end portion of the PCB 110 inserted into the optical sub-assembly 210.

Therefore, the photodetector 250 included in the optical components may be electrically connected to the substrate electrode 112 by the two through vias V3 and V4 passing through all of the first interposer 242 and the second interposer 244 and the electrode pattern 247 which electrically connects the two through vias V3 and V4 with each other and is formed on a lower surface of the first interposer 242.

Furthermore, a portion of the second interposer 242 may be provided at a mount portion 232 which protrudes in an upward direction from a surface of the optical module mount 230. In this case, the second interposer 242 may include a radiating via V5 for transferring heat, occurring in the optical components, to the mount portion 232.

The optical module mount 230 and the mount portion 232 may be provided as one body. Heat occurring in the optical components 250, 260, and 270 may be transferred to the optical sub-assembly 210 through the optical mount module 230 including the mount portion 232 and the radiating via V5.

The optical module mount 230 and the optical sub-assembly 210 may include a material which is good in heat transfer characteristic, for smoothly dissipating heat occurring in the optical components 250, 260, and 270 to the outside. The material which is good in heat transfer characteristic may be, for example, one of aluminum oxide (Al₂O₃), a copper-tungsten (CuW) alloy, silicon (Si), and a composition of at least two materials thereof. Additionally, although not shown in FIG. 2, a heat sink may be coupled to an outer bottom surface of the optical sub-assembly 210.

Furthermore, in order to minimize transmission loss in the interposer 240, a high-speed transmission line 249 may be disposed on the upper surface of the second interposer 244 without being electrically connected to the through vias V1 to V4, and as described above, may be electrically connected to the optical modulator 270 through the bonding wire W1.

Furthermore, as illustrated in FIG. 4, an opening portion 214 may be formed in a bottom surface of the optical sub-assembly 210, so as to align positions of the electrode of the interposer 240 and the substrate electrodes 111 and 112 of the PCB 110 with eyes. Here, the electrode of the interposer 240 may denote upper portions of the through vias V2 and V4 disposed in the ground pattern (248 of FIGS. 2 and 3) patterned on the upper surface of the second interposer 244.

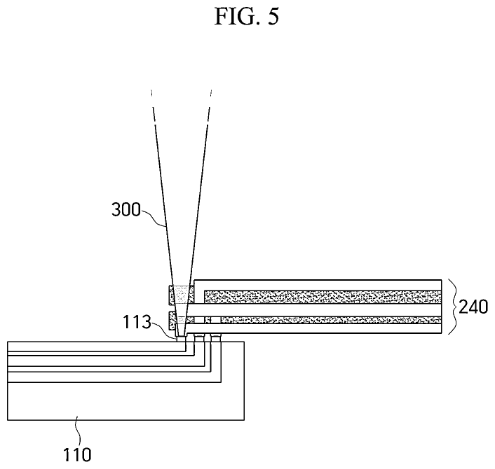

FIG. 5 is a diagram for describing a bonding process between the interposer of the optical sub-assembly and the PCB of the electric sub-assembly of FIG. 2.

Referring to FIG. 5, a bonding process between the PCB 110 of the electric sub-assembly 100 and the interposer 240 of the optical sub-assembly 210 may include, for example, a local laser soldering process. That is, the PCB 110 and the interposer 240 may be bonded to a solder bump 113 melted by a high power laser 300 passing through the opening portion (214 of FIGS. 3 and 4).

Because the interposer 240 according to an embodiment of the present invention includes a transparent material such as glass, the above-described electrode alignment and local laser soldering process may be easily performed.

Comparing with a thermal conduction soldering process of a conventional heating plate process, in the local laser soldering process, laser irradiation may be locally performed on only the solder bump 113, and thus, a bonding process time may decrease and a thermal stress may be minimized.

When bonding between the PCB 110 and the interposer 240 is completed, the opening portion may be sealed by a sealant, and the sealant may include, for example, an epoxy-based material. The sealant may seal a gap between the inserting hole (212 of FIG. 2) and the PCB 110 in a state where one end portion of the PCB 110 is inserted into the inserting hole (212 of FIG. 2) formed in a sidewall of the optical sub-assembly 210.

As described above, in the optical module assembly according to an embodiment of the present invention, the electrode of the interposer may be directly bonded to the electrode of the electric sub-assembly, and thus, a transmission line length may be minimized to enhance an electric bandwidth, thereby implementing the miniaturization and low price of an optical module.

According to the embodiments of the present invention, by using a glass interposer which is low in high frequency transmission loss and includes a transparent material enabling an electrode position to be easily discerned, an optical component of an optical sub-assembly and an electric sub-assembly may be connected to each other by a shortest distance, and thus, an electric bandwidth may be enhanced and a miniaturization design of an optical module may be implemented.

Moreover, the glass interposer may be connected to the electric sub-assembly through local laser soldering, and thus, a total process time of an optical module assembly may be reduced and the manufacturing cost may decrease.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. An optical module assembly comprising:
an electric sub-assembly including a printed circuit board (PCB) and an electronic device mounted on the PCB; and
an optical module including an interposer including a transparent material, an optical sub-assembly accommodating optical components, and a cover covering an upper portion of the optical sub-assembly,
wherein one end portion of the PCB is inserted into the optical sub-assembly through an inserting hole formed in a sidewall of the optical sub-assembly, and the optical components and a substrate electrode formed on a surface of the one end portion of the PCB are electrically connected to each other by the interposer.

2. The optical module assembly of claim 1, wherein the optical components are mounted on the interposer.

3. The optical module assembly of claim 1, wherein the optical component is electrically connected to the substrate electrode by a through via passing through the interposer and an electrode pattern patterned at an inner portion and a surface of the interposer.

4. The optical module assembly of claim 1, wherein the interposer comprises:
a first interposer disposed on an optical module mount formed on an inner bottom surface of the optical sub-assembly; and
a second interposer disposed on the first interposer, and
a ground pattern with the optical components mounted thereon and a high-speed transmission line electrically connected to the optical components by a bonding wire are patterned on an upper surface of the second interposer.

5. The optical module assembly of claim 4, wherein the optical components are electrically connected to the substrate electrode by two through vias passing through the second interposer and an electrode pattern which electrically connects the two through vias with each other and is formed between the first interposer and the second interposer.

6. The optical module assembly of claim 4, wherein the optical components are electrically connected to the substrate electrode by two through vias passing through all of the first interposer and the second interposer and an electrode pattern which electrically connects the two through vias with each other and is formed on a lower surface of the first interposer.

7. The optical module assembly of claim 4, wherein the optical module mount comprises a mount portion protruding in an upward direction from a surface of the optical module mount, a portion of the second interposer being provided on the optical module mount, and
the second interposer comprises a radiating via for transferring heat, occurring in the optical components, to the mount portion.

8. The optical module assembly of claim 7, wherein the optical module mount and the mount portion are provided as one body, and
heat occurring in the optical components are transferred to the optical sub-assembly through the optical mount module including the mount portion and the radiating via.

9. The optical module assembly of claim 8, wherein the optical module mount and the optical sub-assembly comprise a material which is good in heat transfer characteristic, for smoothly dissipating heat occurring in the optical components to the outside, and
the material comprises one of aluminum oxide (Al₂O₃), a copper-tungsten (CuW) alloy, silicon (Si), and a composition of at least two materials thereof.

10. The optical module assembly of claim 1, wherein an opening portion is formed in a bottom surface of the optical sub-assembly, so as to align positions of an electrode of the interposer and the substrate electrode of the PCB with eyes, and
the PCB and the interposer are bonded to a solder bump melted by a high power laser passing through the opening portion.

11. The optical module assembly of claim 10, further comprising a sealant for sealing the opening portion when bonding between the PCB and the interposer is completed.

12. The optical module assembly of claim 11, wherein the sealant comprises an epoxy-based material.
